(19) United States
(12) Patent Application Publication
(10) Pub. No.: US 2004/0063853 A1
(43) Pub. Date: Apr. 1, 2004

(54) Polyoxymethylene moulding material with improved processing stability and a reduced emissions tendency

(76) Inventors: Stefan Disch, Frankfurt (DE); Peter Eckardt, Hofheim (DE); Karl-Friedrich Muck, Wiesbaden (DE); Gerhard Reuschel, Liederbach (DE); Lothar Reissmann, Hofheim (DE)

Correspondence Address: CONNOLLY BOVE LODGE & HUTZ, LLP, P O BOX 2207, WILMINGTON, DE, 19899, US

(21) Appl. No.: 10/663,290

(22) Filed: Sep. 16, 2003

Related U.S. Application Data
(62) Division of application No. 09/647,743, filed on Oct. 4, 2000.
Application No. 09/647,743 is a 371 of international application No. PCT/EP99/02280, filed on Apr. 1, 1999.

(30) Foreign Application Priority Data
Apr. 8, 1998 (DE) DE 198 15 663.4

(51) Int. Cl. C08K 3/00

(52) U.S. Cl. 524/593

(57) ABSTRACT

Molding compositions made from linear polyoxymethylene copolymers which essentially have oxymethylene units and oxyethylene units as structural units in the polymer chain, where the proportion of oxyethylene units in the structural units of the polymer chain is from 1.5 to 2.5 mol %. These molding compositions, and also uncolored or colored moldings produced from these have high stability and extremely low emission of formaldehyde and of residual monomers. At the same time they have a high level of mechanical properties, and they can therefore be utilized without restriction for the customary application sectors and processing methods.

### DESCRIPTION

Polyoxymethylene molding composition with improved stability during processing and reduced emission tendency

The present invention relates to a polyoxymethylene molding composition which has particularly high stability, and to its use for producing low-emission moldings. These materials are particularly suitable for producing colored moldings with low emissions.

Since they were introduced to the market about 30 years ago, polyoxymethylenes (POMs) have become established as extremely useful materials for a variety of technical applications. POM is particularly widely used as a material in designs for automotive construction or for the electrical industry. Examples can be found in the technical service brochures of POM producers.

POM copolymers and their preparation are by now well known (Sabel et al., in Becker/Braun Eds., Kunststoff-Handbuch, Vol. 3/1). For example, it is now well known that trioxane can be copolymerized with cyclic ethers using cationic initiators. The usual cationic initiators used are Lewis acids, such as BF₃, strong protonic acids, such as HClO₄, heteropolyacids or perfluoroalkanesulfonic acids. The comonomer used is usually ethylene oxide or the cyclic formal of ethylene glycol, butanediol or diethylene glycol.

In principle the comonomer content in the POM copolymer can be varied very widely. For example, JP07286024 gives a range of from 0.03 to 10 mol % of comonomer units in the polymer for copolymers of oxymethylene and C₂-C₄-oxyalkylenes modified with long-chain aliphatic end groups. JP07124996 gives a general description of a POM copolymer in which the proportion of comonomer in the polymer may be from 3 to 30% by weight.

The comonomer content generally given for the preparation of POM copolymers is from 3 to 4% by weight, and this data is to be understood as the proportion by weight of the comonomer in the monomer mixture (examples: JP07286023; JP06049155; JP04108819).

To obtain products of greater stability, POM molding compositions are treated for a prolonged period with aqueous ammonia solution (JP54107972) or heated in aqueous suspension under pressure at from 100 to 200° C. (NL-A6812966).

Products made from POM copolymers have long been produced commercially and used for engineering components. A certain level of mechanical properties, such as stiffness, hardness and toughness, is required here from POM molding compositions, and it is only this which allows the use of these materials for engineering components such as gear wheels, levers and many others. The yield stress values published in the brochures of POM copolymer manufacturers are from 60 to 70 N/mm². The values found there for the modulus of elasticity of unmodified copolymers are from 2400 to 3100 N/mm². The values found for notched impact strength at 23° C. are from 4 to 12 mJ/mm².

Because POM molding compositions have these advantageous properties there is the requirement to give these materials access to more application sectors. A demand increasingly met with, alongside maintenance of the mechanical property profile, is that there should only be very little emission of residual monomers or of other volatile constituents from moldings. The automotive industry, one of the most important markets for products made from POM, has developed specific analysis methods for this purpose (VDA Empfehlung Nr. 275 [German Automotive Industry Recommendation No. 275], documented by Kraftfahrwesen e.V., July 1994). A low proportion of residual monomers and of other volatile constituents is also important with respect to the coloration of POM, since POM is particularly difficult to color (cf. Damm W., Herrmann E., in Gächter, Müller; 3rd Edition, p. 730).

Although the commercially produced POM products currently obtainable have the known advantageous mechanical properties, the moldings produced from these have excessive emission of 30 mg/kg or more of formaldehyde. Attempts are made to achieve a lower emission level by complicated post-treatment of the moldings, e.g. by intensive annealing. However, the post-treatment gives rise to additional costs.

The POM stabilization systems described in a variety of patents, generally using certain formaldehyde scavengers, have hitherto also been unable to overcome the defect of high emissions. Low-emission moldings cannot be produced reliably from the POM molding compositions which have hitherto been customary.

There was therefore a need to develop POM molding compositions which firstly have a substantially reduced emission tendency and secondly have the level of mechanical properties which is known and required by the industry.

The object is achieved by linear POM copolymers which essentially have oxymethylene units and oxyethylene units as structural units in the polymer chain, where the proportion of oxyethylene units in the structural units of the polymer chain is from 1.5 to 2.5 mol %, preferably from 1.85 to 2.25 mol %.

Surprisingly, the novel molding compositions specifically have firstly substantially improved stability, so that the residual emission levels of moldings produced from these are extremely low. For example, formaldehyde emission, measured on sheets of wall thickness 1 mm after 24 hours of storage, in accordance with VDA 275, is generally less than 15 mg/kg, preferably less than 10 mg/kg.

Secondly, the mechanical properties of the novel molding compositions meet the customary requirements placed upon commercially available POM products, and they can therefore be utilized without restriction for the application sectors and processing techniques customary for POM.

The novel molding compositions are composed of linear POM copolymers which essentially have only oxyethylene units as co-component in the polymer chain alongside oxymethylene units. In principle, the copolymer may also contain a small proportion of longer-chain units, e.g. C₃- or C₄-oxyalkylene units. However, these impair mechanical properties at a constant low emission tendency.

In the novel molding compositions, the proportion of oxyethylene units in the structural units of the polymer chain is generally 2.0±0.5 mol %, i.e. from 1.5 to 2.5 mol %. Their proportion is preferably from 1.85 to 2.25 mol %. The proportion of longer-chain oxyalkylene units should generally not exceed 0.6 mol %, preferably 0.3 mol %, of the structural units of the polymer chain. The total of oxyethylene units and longer-chain oxyalkylene units in the structural units of the polymer chain is also generally from 1.5 to 2.5 mol %, preferably from 1.85 to 2.25 mol %.

Although POM copolymers whose proportion of comonomer units is higher than that of the novel products likewise have the required low emission values, their substantially lower stiffness and strength values mean that they cannot be used in the application sectors known for POM.

The novel POM copolymers may be prepared by well known preparation processes. An example of a possible process is the copolymerization of trioxane with from 4 to 6% by weight, preferably from 4.5 to 5.5% by weight, of dioxolane in the presence of generally customary amounts of BF₃ and methylal, where the amount of dioxolane is based on the total of dioxolane and trioxane. The proportion of the comonomer in the monomer mixture is correspondingly from 4.8 to 7.2 mol %, preferably from 5.4 to 6.6 mol %.

The customary stabilizers and auxiliaries, such as antioxidants, mold-release aids, acid scavengers, nitrogen-containing costabilizers and nucleating agents may be added either individually or as a mixture to the novel POM copolymers, if desired together with colorants. The addition of stabilizers may, however, also be reduced or dispensed with, since the stability of the novel copolymers is in any case high.

The extremely low emission values of the novel POM copolymer molding compositions mean that they can particularly advantageously be used directly for producing low-emission moldings. No post-treatment of the moldings by annealing is now required, and their overall production is therefore more cost-effective.

Particular application sectors for the novel molding compositions are internal fittings and claddings of means of transport, such as automobiles, aircraft, railroad cars, etc., household products, toys, in particular children's toys, items for babies, and also devices and components for electrical engineering and electronics. The novel molding composition is particularly suitable for producing colored moldings and for producing low-emission apparatuses and instruments, or parts of these, for medical applications, for example inhalers.

### EXAMPLES

In the examples which follow the properties of materials were determined by the following methods:

Melt index in accordance with ISO 1133 at 190° C. and with a weight of 2.16 kg applied;

modulus of elasticity in accordance with ISO 527;

yield stress in accordance with ISO 527;

notched impact strength in accordance with ISO 179;

formaldehyde emission: sheets of wall thickness 1 mm were manufactured from the POM copolymer molding compositions. The formaldehyde emission from the sheets was determined in accordance with VDA 275 after 24 hours in storage.

The results of the materials testing for the examples below are given in Table 1.

### Example 1

3400 g of trioxane were copolymerized with 190 g of dioxolane in the presence of 35 ppm of BF₃ and 1200 ppm of methylal. After removal of unconverted monomers, initiator residues and unstable end groups were removed by dissolving and heating the copolymer in a methanol/water/trioxane mixture at 180° C. at superatmospheric pressure. The proportion of oxyethylene units in the resultant copolymer was 2.05 mol %. This polymer was melted in a kneader and mixed with antioxidant, acid scavenger and additives in the same proportions as in the comparative polymer. Pellets were produced from the mixture, and these were injection molded to give the test specimens for determining the modulus of elasticity, yield stress and notched impact strength, and to give the sheets for determining formaldehyde emission. The melt index was likewise determined on the mixture.

### Comparative Example 1

3400 g of trioxane were copolymerized with 275 g of dioxolane in the presence of 35 ppm of BF₃ and 1200 ppm of methylal. After removing unconverted monomers, initiator residues and unstable end groups were removed as in Example 1. The proportion of oxyethylene units in the resultant copolymer was 3.1 mol %. The copolymer was melted as in Example 1, mixed with antioxidant, acid scavenger and additives, pelletized and molded to give test specimens.

### Comparative Example 2

Commercially available POM copolymer (Hostaform®) with a melt index comparable to that of Example 1 at 28 g/10 min, was used as in Example 1 to manufacture sheets of wall thickness 1 mm, of which the formaldehyde emission was determined.

### Example 2

3400 g of trioxane were copolymerized with 180 g of dioxolane in the presence of 35 ppm of BF₃ and 800 ppm of methylal. After removing unconverted monomers, initiator residues and unstable end groups were removed as in Example 1. The proportion of oxyethylene units in the resultant copolymer was 1.92 mol %. The copolymer was melted as in Example 1, mixed with antioxidant, acid scavenger and additives, pelletized and molded to give test specimens.

### Comparative Example 3

Commercially available POM copolymer (Hostaform®) with a melt index comparable to that of Example 2 at 13 g/10 min, was used as in Example 1 to manufacture sheets of wall thickness 1 mm, of which the formaldehyde emission was determined.

### Example 3

3400 g of trioxane were copolymerized with 200 g of dioxolane in the presence of 35 ppm of BF₃ and 600 ppm of methylal. After removing unconverted monomers, initiator residues and unstable end groups were removed as in Example 1. The proportion of oxyethylene units in the resultant copolymer was 2.13 mol %. The copolymer was melted as in Example 1, mixed with antioxidant, acid scavenger and additives, pelletized and molded to give test specimens.

### Comparative Example 4

3400 g of trioxane were copolymerized with 280 g of dioxolane in the presence of 35 ppm of BF₃ and 600 ppm of methylal. After removing unconverted monomers, initiator residues and unstable end groups were removed as in Example 1. The proportion of oxyethylene units in the resultant copolymer was 3.22 mol %. The copolymer was melted as in Example 1, mixed with antioxidant, acid scavenger and additives, pelletized and molded to give test specimens.

### Comparative Example 5

Commercially available POM copolymer (Hostaform®) with a melt index comparable to that of Example 3 at 9 g/10 min, was used as in Example 1 to manufacture sheets of wall thickness 1 mm, of which the formaldehyde emission was determined.

### Example 4

3400 g of trioxane were copolymerized with 200 g of dioxolane in the presence of 35 ppm of BF₃ and 1600 ppm of methylal. After removing unconverted monomers, initiator residues and unstable end groups were removed as in Example 1. The proportion of oxyethylene units in the resultant copolymer was 2.08 mol %. The copolymer was melted as in Example 1, mixed with antioxidant, acid scavenger and additives, pelletized and molded to give test specimens.

### Comparative Example 6

Commercially available POM copolymer (Hostaform®) with a melt index comparable to that of Example 4 at 50 g/10 min, was used as in Example 1 to manufacture sheets of wall thickness 1 mm, of which the formaldehyde emission was determined.

TABLE 1

| | | | | | Notched | |
|---|---|---|---|---|---|---|
| | Oxyethylene | Melt | Modulus of | Yield | impact | Formaldehyde |
| | units | index | elasticity | stress | strength | emission |
| | mol % | g/10 min | N/mm² | N/mm² | mJ/mm² | mg/kg |
| Example 1 | 2.05 | 27 | 2650 | 61 | 7 | 7 |
| Comparative | 3.10 | 28 | 2100 | 52 | 9 | 5 |
| Example 1 | | | | | | |
| Comparative | 1.31 | 28 | | | | 35 |
| Example 2 | | | | | | |
| Example 2 | 1.92 | 13 | 2680 | 62 | 6.5 | 8.2 |
| Comparative | 1.43 | 13 | | | | 30 |
| Example 3 | | | | | | |
| Example 3 | 2.13 | 9 | 2580 | 60 | 7.5 | 6.5 |
| Comparative | 3.22 | 9 | 2050 | 50 | 9 | 4 |
| Example 4 | | | | | | |
| Comparative | 1.34 | 9 | | | | 33 |
| Example 5 | | | | | | |
| Example 4 | 2.08 | 50 | 2580 | 60 | 7.5 | 6.5 |
| Comparative | | | | | | |
| Example 6 | 1.32 | 50 | | | | 33 |

1. A molding composition made from linear polyoxymethylene copolymers which essentially have oxymethylene units and oxyethylene units as structural units in the polymer chain, where the proportion of oxyethylene units in the structural units of the polymer chain is from 1.5 to 2.5 mol %, preferably from 1.85 to 2.25 mol %.

2. A molding composition as claimed in claim 1, which has a formaldehyde emission, measured on sheets of wall thickness 1 mm after 24 hours in storage, in accordance with VDA 275, of less than 15 mg/kg, preferably less than 10 mg/kg.

3. A molding composition as claimed in claim 1 or 2, which has a modulus of elasticity in accordance with ISO 527 of from 2400 to 3100 N/mm², a yield stress in accordance with ISO 527 of from 60 to 70 N/mm² and a notched impact strength in accordance with ISO 179 at 23° C. of from 4 to 12 mJ/mm².

4. A molding composition as claimed in any of claims 1 to 3, which comprises antioxidants, acid scavengers, stabilizers and colorants.

5. The use of a molding composition as claimed in any one of claims 1 to 4 for producing moldings which have a formaldehyde emission of less then 15 mg/kg, preferably less than 10 mg/kg.

6. The use of a molding composition as claimed in any one of claims 1 to 4 for producing colored moldings.

7. The use as claimed in claim 5 or 6 for low-emission moldings for interior fittings or interior cladding in means of transport, such as automobiles, aircraft and rail road cars.

8. The use as claimed in claim 5 or 6, for household products, recreational items, in particular children's toys, and items for babies.

9. The use as claimed in claim 5 or 6 for devices and components for electrical engineering and electronics.

10. The use as claimed in claim 5 or 6 for apparatuses and instruments for medical applications.
